(19) United States
(12) Patent Application Publication
(10) Pub. No.: US 2024/0004358 A1
(43) Pub. Date: Jan. 4, 2024

(54) METHODS AND SYSTEMS FOR GENERATING AND TRANSMITTING CUSTOMIZED NOTIFICATIONS REGARDING A STATUS OF AT LEAST ONE BUILDING ASSET

(71) Applicant: Building Assure PBC, Concord, MA (US)

(72) Inventors: Josef Charles Mueller, III, Concord, MA (US); Gordon James Davidson, Chandler, AZ (US)

(21) Appl. No.: 18/214,402

(22) Filed: Jun. 26, 2023

Related U.S. Application Data
(60) Provisional application No. 63/356,696, filed on Jun. 29, 2022.

(51) Int. Cl. G05B 15/02; G06Q 40/06

(52) U.S. Cl. CPC G05B 15/02; G06Q 40/06

(57) ABSTRACT

A method for generating and transmitting customized alerts regarding a status of at least one building asset of a building includes receiving, by a computing device, for at least one building asset of a building, maintenance data associated with the at least one building asset, at least one maintenance datum received from at least one sensor associated with the at least one building asset. A machine learning engine analyzes the received maintenance data to identify at least one characteristic associated with the at least one building asset. The method includes generating, for the at least one building asset, a notification associated with the at least one building asset, responsive to the identified at least one characteristic. The method includes transmitting, for the at least one building asset, to at least one user associated with the at least one building asset, at least one notification associated with the generated notification.

### CROSS-REFERENCE TO RELATED APPLICATIONS

This application claims the benefit of U.S. Provisional Patent Application Ser. No. 63/356,696, filed on Jun. 29, 2022, entitled “Method for Generating and Transmitting Customized Notifications Regarding a Status of At Least One Building Asset,” which is hereby incorporated by reference.

### BACKGROUND

Buildings may be considered to be eco-systems having a variety of stakeholders (owners, tenants, service providers, utilities, and other third parties) and interests. Each stakeholder group typically has their own methods, processes, and systems to support their interests and objectives. Those interests may be complimentary or adversarial; at times, those interests and objectives are both complimentary and adversarial. There is a need for technological solutions that provide shared, trusted, and timely methods, processes, and systems that are available and accessible to stakeholders.

Building owners typically have a significant investment in their assets and may be concerned about protecting that investment, as well as being concerned about attracting/retaining quality tenants (ideally with long-term commitments). One challenge building owners may face is a desire to balance the cost of risk reduction vs. cost while maintaining the cost of delaying or avoiding risk mitigation in order to maintain positive cash flow. Risks to protecting that investment include without limitation: tenant damage (intentional and unintentional); inefficient energy use of consumable resources (electricity, water, fuel) resulting in higher ongoing costs and reducing the life expectancy of their assets and equipment; tater damage; environmental conditions exposing the owner to liability and reputational impact; health and safety issues that could result in loss of life and/or a requirement for long-term care; repairs and maintenance completed substandard, infrequently, or not at all; vacancies and loss of rental income due to inattention to the items above; and/or changes to government (local, regional, federal) regulatory rules and mandates, or initiatives affecting permits, occupancy, zoning, and other areas requiring building owner compliance. However, building owners do not conventionally understand the status of one or more building assets or building conditions in one or more buildings. Building owners do not conventionally have tools that provide reliable insights about conditions and assets. They typically learn something is at risk when it fails, which can be catastrophic if it happens when there is a delay between a failure and a notification (e.g., if the failure occurs when the building is empty and/or no one is available to report the failure or to receive the report). Yet, conventional current building management systems are designed for large enterprise sized buildings and campuses with personnel dedicated to their use and are not typically scalable down for use with small and medium sized buildings. As a result, building owners managing smaller buildings primarily use reactionary systems that focus on fire safety and security, tenant complaints, feedback from contractors, and their own observation when something fails. To further complicate problems, most small and medium sized building owners do not typically have service contracts in place to manage routine maintenance and servicing. Furthermore, owners of smaller buildings are conventionally hesitant to make decisions requiring investment. They typically lack dedicated technical resources, expertise, and time. They typically have no methods or tools to evaluate whether services have been performed, the quality of service, or the impact. They typically have little or no visibility into the cost of “doing nothing.”

Tenants conventionally require building space that is flexible, worry free, and cost effective. Like building owners, tenants also need to balance the cost of risk reduction vs the cost while maintaining of delaying or avoiding risk mitigation in order to maintain positive cash flow. Risks to protecting their investment include, as an example for commercial tenants, health and comfort of employees and customers, related to air quality, temperature, humidity, mold prevention, and environmental impacts exposing the tenant to liability and reputational impact; loss in productivity due to equipment failures, personnel impacting conditions, and environmental issues; higher operating costs, because of wasted consumable resource usage, poor service providers, and an understanding of risk reduction vs. cost; and/or a loss of customers due to inattention to the items above.

Both building owners and tenants require access to shared and timely methods, processes, and systems (on-site and remotely) that they can trust and utilize to make decisions. This may include both historical and current asset conditions, servicing quality and intervals, and related environmental conditions to provide effective and efficient servicing of the various building assets.

Third parties may also benefit from access to the same shared and timely methods, processes, and systems. (e.g., service companies may benefit from functionality to provide quality and timely asset maintenance that owners and tenants can trust). Insurance companies may want access to the same data to provide asset and owner protection at reasonable cost to the building owner, and to develop new risk profiles.

One problem faced in implementing a conventional solution includes a lack of quality, reliable service information, such as when the building asset was last serviced, what service was performed, what settings were changed and when and by whom, how did the performance improve or degrade compared to historical performance, or against industry norms or manufacturers recommendations when service was performed, or settings were adjusted. In some instances, service personnel are contracted to perform routine maintenance, and in other instances, building owners or tenants prefer to undertake the work themselves. Additionally, corrective, or preventative service is often delayed or avoided due to lack of understanding, skills, or access to a fact base by small building owner or business owner to make a sound business decision, a low level of trust in the service provider providing the services has properly and completely addressed the service condition for a price that provides value to the building owner or tenant, or due to missing or forgetting recommended servicing. As a result, hazardous conditions may go unnoticed, equipment can fail prematurely, servicing is not performed satisfactorily, significant consumable resources and money is wasted, and the opportunity for significant job growth is not realized.

Building owners can no longer afford to be reactive or indecisive for a variety of reasons including, without limitation, providing healthy and safe buildings may not be optional, tenants may be questioning the need/value for their building space, uncontrollable costs may have increased, some controllable costs may be avoided (e.g., waste of consumable resources), unplanned/emergency repairs may need to be minimized, and/or more efficient decisions may need to be made in determining whether to repair or replace building assets. However, conventional tools available to such building owners do not typically provide functionality supporting those needs. Such tools do not conventionally target the small building sector and fail to provide solutions that are downwards scalable and/or affordable. Therefore, there is a need for technology that may be used to provide support in the management of buildings, including commercial buildings.

### BRIEF SUMMARY

In one aspect, a method for generating and transmitting customized alerts regarding a status of at least one building asset of a building includes receiving, by a computing device, for at least one building asset of a building, maintenance data associated with the at least one building asset, at least one maintenance datum received from at least one sensor associated with the at least one building asset. The method includes analyzing, by a machine learning engine in communication with the computing device, the received maintenance data to identify at least one characteristic associated with the at least one building asset. The method includes generating, for the at least one building asset, a notification associated with the at least one building asset, responsive to the identified at least one characteristic. The method includes transmitting, for the at least one building asset, to at least one user associated with the at least one building asset, at least one notification associated with the generated notification.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a flow diagram depicting one embodiment of a method for generating and transmitting customized notifications regarding a status of at least one building asset to at least one shareholder;

FIG. 2 is a block diagram depicting an embodiment of a building for which a method generates and transmits customized notifications regarding a status of at least one building asset;

FIG. 3 is a flow diagram depicting one embodiment of a method for generating and transmitting customized notifications regarding a status of at least one building asset to at least one shareholder;

FIG. 4 is a flow diagram depicting one embodiment of a method for generating and transmitting customized notifications regarding a status of at least one building asset;

FIGS. 5A-5C are flow diagrams depicting embodiments of a method for updating data in a system for generating and transmitting customized notifications regarding a status of at least one building asset;

FIG. 6 is a flow diagram depicting an embodiment of a method for populating alert data in a system for generating and transmitting customized notifications regarding a status of at least one building asset;

FIG. 7 is a block diagram depicting an embodiment of a user interface for a building alerts application in a system for generating and transmitting customized notifications regarding a status of at least one building asset;

FIG. 8 is a flow diagram depicting an embodiment of a method for generating and transmitting customized notifications regarding a status of at least one building asset; and

FIGS. 9A-9C are block diagrams depicting embodiments of computers useful in connection with the methods and systems described herein.

### DETAILED DESCRIPTION

The methods and systems described herein provide functionality that may be used to assure healthy, safe buildings and educate building stakeholders. The methods and systems described herein provide functionality that may be used to lower controllable operating expenses and grow revenue. The methods and systems described herein provide functionality that may be used to decarbonize buildings and avoid wasting the planet's limited resources. The methods and systems described herein provide functionality that may be used to offer services that are accessible, affordable, and valued by all communities. The methods described herein include, without limitation, execution of functionality to assess risk and consequence, alert building owners and tenants, and provide access to collected data that is trusted to take appropriate action to correct, prevent, mitigate issues, and adjust conditions and behavior to minimize future risk.

The methods and systems described herein provide functionality that may be used to increase building stakeholder awareness of conditions of building assets. The methods and systems described herein provide functionality that may be used to transmit customized notifications regarding a status of at least one building asset. As will be understood by those of ordinary skill in the art, building assets of a building may refer to infrastructure in or associated with a physical structure (i.e., a building) and building conditions may refer to an internal operating condition within the physical structure (e.g., without limitation, air quality, safety level, environmental conditions, and/or risk of a hazard such as fire, or mold). The methods and systems described herein provide functionality that may be used to transmit customized notifications regarding the status of at least one building condition. The methods and systems described herein provide functionality that may be used to provide timely acknowledgement and response to issues. The methods and systems described herein provide functionality that may be used to access and analyze data used to support evaluation and resolution. The methods and systems described herein provide functionality that may be used to increase access to return on investment data for repair, replace, or do-nothing decisions. The methods and systems described herein provide functionality that may be used to identify and assess a level of completion and/or a level of quality in one or more services performed for one or more building services. The methods and systems described herein provide functionality that may be used to provide timely and/or transparent communication across a plurality of building shareholders.

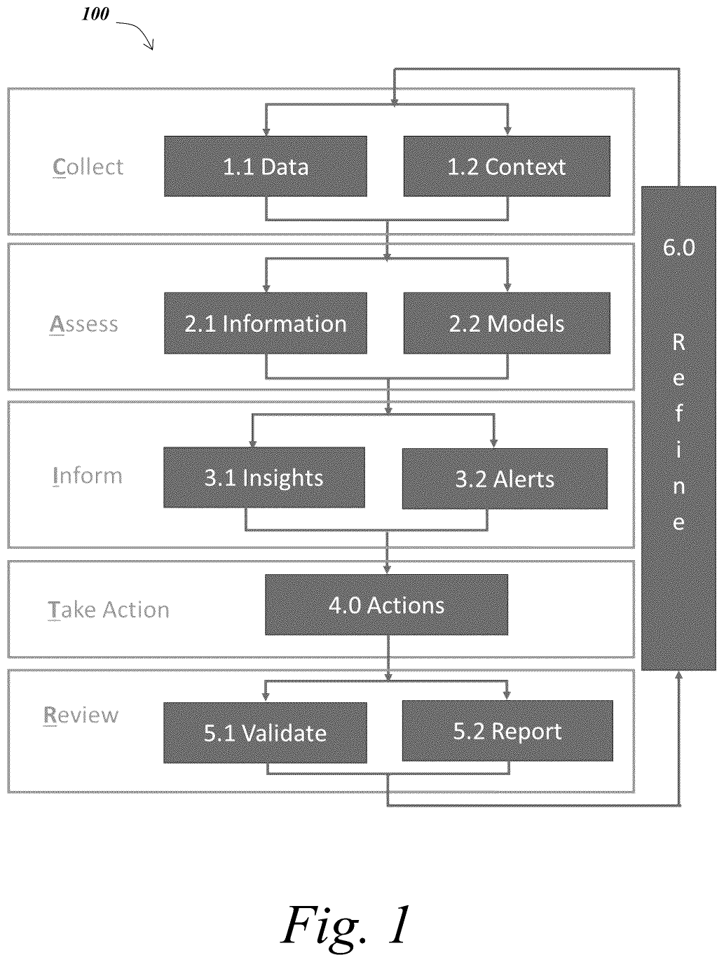

Referring now to FIG. 1, a flow diagram depicts one embodiment of a method 100 for providing shareholders—such as building owners, tenants, and interested third parties—with information to achieve business goals and minimize risk to health, safety, and the environment. The method 100 may be referred to herein as “CAITR” or “the CAITR method.” CAITR may include these steps: Collect, Assess, Inform, Take Action, and Review. CAITR may include a sixth step to repeat the process after incorporating newly generated data.

As shown in FIG. 1, the method 100 includes a data collection step. The collection of data includes, without limitation, collection of data from sources such as building assets, devices, sensors, data loggers, servicing records, environmental records, and consumption records such as but not limited to utility meters, utility bills. Data may be entered manually (e.g., from existing servicing records). Data may be entered automatically (e.g., from sensors and data loggers).

Collected and analyzed data may generally be referred to herein as maintenance data. Such maintenance data may relate to indoor air quality, including for example, temperature, humidity, and air quality (e.g., levels of CO2, PM2.5, etc.). Maintenance data may include resource utilization data (e.g., utilization of electricity, fuel, and water). Maintenance data may include event-related data (e.g., data relating to the opening or closing of doors or windows, data gathered by proximity sensors, and data gathered by motion detectors). Maintenance data may include local weather conditions (e.g., received from a rooftop weather station or other source of weather-related information). Maintenance data may include external event data received from third party sources (e.g., data received from the National Weather Service or from EPA AirNow). Maintenance data may include data received from users (e.g., user-generated conditions, events, and/or issues). Maintenance data may include data relating to one or more building assets (e.g., relating to Heating Ventilation and Air Conditioning systems (HVAC systems), thermostats, water heaters, etc.). Maintenance data may include data relating to maintenance data associated with a particular building asset (e.g., a type of service performed, a last service date, an identification of a level of performance by an asset such as current draw or HVAC air temperature in/out).

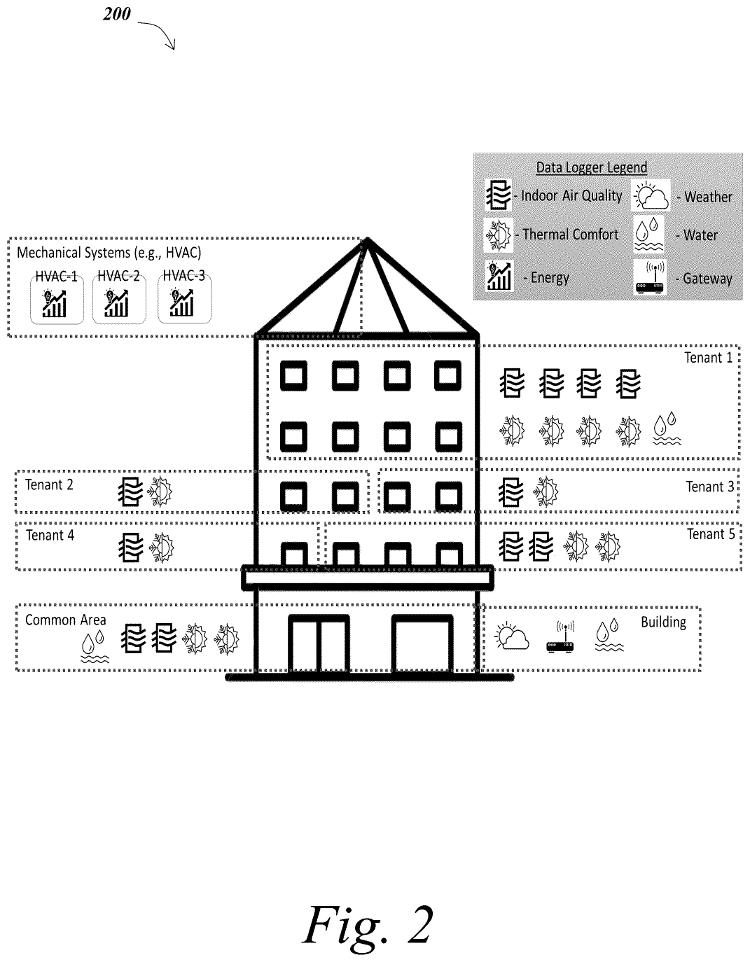

Referring ahead to FIG. 2, a block diagram depicts a system 200 including a sample building with the various assets and data loggers. As shown in FIG. 2, a building may include at least one tenant. A building may include at least one mechanical system (e.g., an HVAC system). A building may include one or more data loggers to collect data including, without limitation, data relating to indoor air quality, thermal comfort, energy, weather water quality, and/or telecommunications services.

Referring back to FIG. 1, the method 100 includes identifying a context—that is, one or more parameters associated with a building, one or more building assets, devices, and/or data loggers. Parameters may include, without limitation, configuration information, environmental settings, external factors (outdoor weather, air quality, and events), whether the space occupied or unoccupied, recommended servicing intervals and procedures per manufacturer or industry standards, and responsible parties (personnel) for responding to alerts and reminders who then initiate the appropriate actions. This information may be entered manually. The information may be retrieved automatically, such as, for example, via information feeds for weather conditions, manufacturers information, and others where available.

As shown in FIG. 1, the method 100 includes assessment of the collected data. The assessment may include analyzing the received data and matching the received data with at least one context. The method may include presenting the data and the associated context as summarized, organized, and analyzed information in a dashboard and/or generating reports made available to one or more building stakeholders. Data analyzed may include historical events and conditions associated with one or more building assets, historical performance of one or more building assets, and historical utility bills associated with one or more building assets. Summary information includes but is not limited to time bins (hourly, daily, weekly, monthly, annually) and by type (such as HVAC or water heater, for example). Organized information includes but is not limited to grouping of time bins (such as usage of consumable resources during occupancy hours and during non-occupied hours) and for similar conditions (such as outdoor weather conditions and the same environmental settings such as temperature). Analyzed information includes but is not limited to status of assets or devices such as compressor or fan state (on/off), duration, accumulated run time of compressor or fan.

The method 100 may including executing one or more artificial intelligence engines, each of which may execute one or more algorithms to model the collected data and provide descriptive, predictive, and/or prescriptive information. Such engines may utilize various modeling types such as but not limited to statistical, simulation, rules based, and machine/deep learning.

The method 100 includes an informing step, providing at least one stakeholder with data or metadata regarding the building. The method may include providing interested parties with insights, alerts, and/or reminders. As used herein, the term “notification” may refer to an insight generated by one or more machine learning engines, an alert, a reminder, a report, or any message generated by the system or a user and sent to a building stakeholder.

The method 100 may include presenting the information and models to building owners, tenants, contractors, and third parties for further analysis or consumption. Insights may include comparisons, cost analyses, and/or trends. Examples would include asset servicing intervals for insurance rating companies or contractors for validating product servicing intervals vs standards. The method 100 may including comparing information against pre-established thresholds to alert responsible parties of conditions and/or events that require investigation, and the level of urgency associated with these alerts. A user may specify how to receive alerts and the manner of receiving alerts may include, but are not limited to, phone calls, messaging via software applications, text message, and/or email. Users may also manually enter alerts for conditions that need to be addressed or for which the users should receive reminders. Examples of alerts include, without limitation, higher than normal water, electricity and/or fuel consumption by the HVAC unit or poor air quality. Alerts may also include reminders on assets that require periodic or routine maintenance and servicing based on manufacturer recommendations and industry norms. The reminders also include the necessary part number as appropriate. Examples would be the regular replacement of an HVAC air filter or batteries in a sensor.

The method 100 includes the step of taking action based on the generated insights and/or alerts. Based on the insights and alerts generated by the execution of the method, building owners, tenants, and service personnel may be prompted to acknowledge and respond based on the insights, alerts, and reminders generated. After evaluating the alert, responses may be preventative, corrective and/or routine actions or can also be a decision to ignore. Some responses will involve servicing building assets. Actions may relate to services and resolutions, reduction in consumable resource usage, cost reduction, service tickets, alert histories, and service histories.

The method 100 may include reviewing and validating the results of actions taken. Based on the actions taken, the system may review results and validate the results against expectations. For example: Did the action resolve the alerted condition? Did the action happen in a timely manner? Did the action have the desired financial impact? How did the action impact people, financial, or asset performance? Does the process need revision or enhancement? The system may make additional service integrity check alerts, asset service recommendations, or make new service integrity check resolutions. The actions may result in new data, context modification, and/or revisions to the CAITR method.

The method 100 may include a reporting step. The method may execute a reporting engine providing functionality for compliance reporting, routine analysis, and ad-hoc reporting covering known and unknown needs. As an example, annual reporting of electricity and water consumption is now a requirement in New York City for larger buildings and will eventually make its way to smaller buildings, and potentially other communities. Businesses (and buildings) may have different types of consumable resources used and different types of electricity sources (e.g., renewable) and may have different reporting requirements for each.

The method may include utilizing the results of the steps above to update the data stream, resulting in continual refinement of the method 100. Therefore, the CAITR method 100 may continually repeat as data and/or context may be impacted, and new data may generate initiating added information, or updated modeling, which in turn may generate new insights and alerts. Such a method may ensure continuous improvement and refinement of the efforts to the goals of the building owner and tenant.

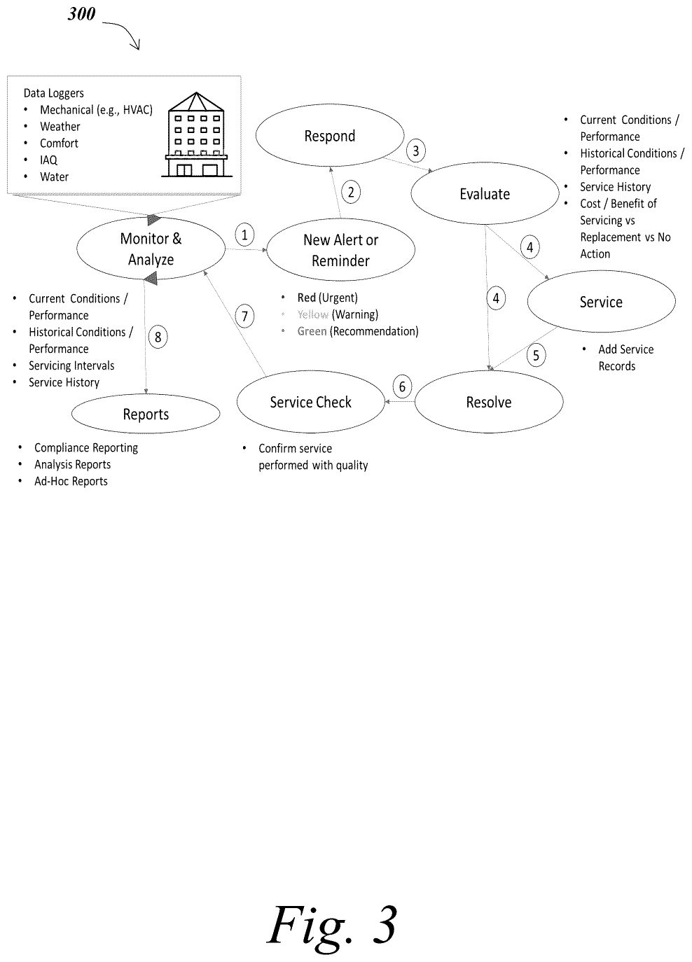

Referring now to FIG. 3, and in connection with FIGS. 1-2, a flow diagram depicts one embodiment of the method 300 for generating and transmitting customized notifications regarding a status of at least one building asset to at least one shareholder providing shareholders. The method 300 may include execution of functionality to facilitate the collection, alerting, and reminding of building owners, tenants, and service personnel. These groups may otherwise have little to no visibility, on-site or via remote access, into the performance of building assets, including but not limited to equipment, data loggers, and sensors that monitor health and safety, thermal comfort, serviced needed, and consumable resource efficiency, and that provide one or more alerts when service conditions require awareness and or remedial action. In one embodiment, the methods and systems described herein provide functionality to provide building owners, tenants, and service personnel with actionable and timely information and history of building alerts and service integrity checks to initiate actions to achieve optimum health and safety, thermal comfort, consumable resource efficiency, and service awareness to build trust and confidence in the optimum performance of building assets.

In one embodiment, a system executing the methods described herein uses the following resources: a building, one or more building assets associated with the building, such as HVAC, water heater, in-building electrical distribution, plumbing, etc., sensors, devices, and/or data loggers to provide data, utility bills for consumption information, asset manufacturer information (model numbers, warranty data, servicing intervals, etc.), local weather and outdoor air quality information, and identification of service contractors if any.

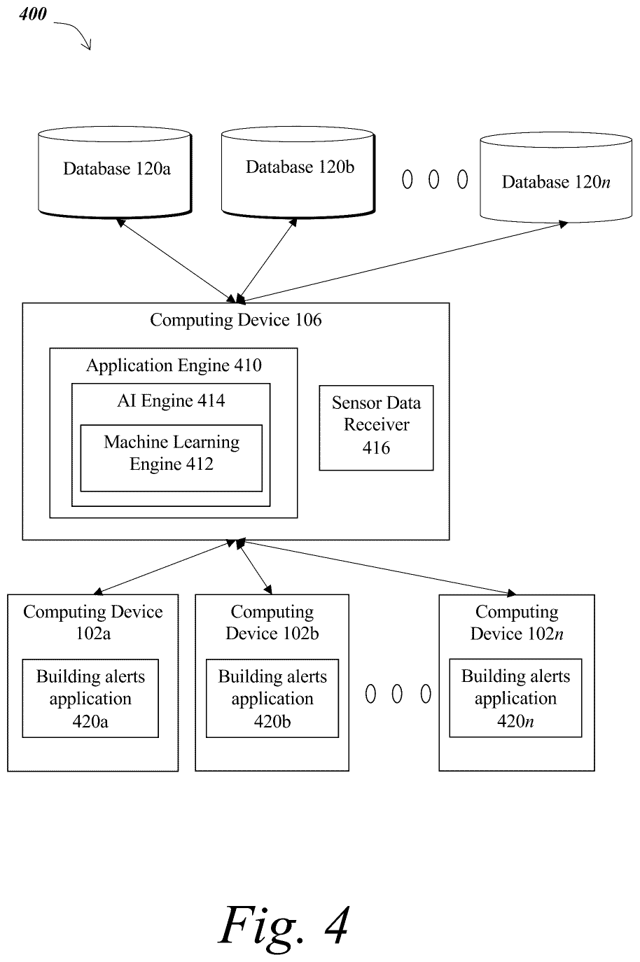

Referring now to FIG. 4, a block diagram depicts one embodiment of a system 400 for generating and transmitting customized notifications regarding a status of at least one building asset. The system 400 may execute functionality for creation, maintenance, and management of building asset and service integrity check databases. The system 400 includes a plurality of databases 120a-n. The system 400 includes a computing device 106a executing an application engine 410.

The application engine 410 may generate one or more building alerts. The application engine 410 may generate one or more service integrity checks.

The computing device 106a may include or be in communication with one or more databases 120a-n. The databases 120 may store current data. The databases 120 may store historical data. Stored data may include, without limitation, performance data, site and asset information, external conditions and events, collected data, input data, building alerts, service checks, alerts, recommended servicing intervals, recommended services, performance criteria, responsible personnel, alert configurations, service tickets, and/or service history.

Building alerts may include alerts relating to health and wellness, thermal comfort, energy efficiency, water, and service needed. Service integrity checks may include alerts for one or more devices.

The application engine 410 may include or be in communication with a machine learning engine 412 executing as described in greater detail below. The application engine 410 may include or be in communication with an artificial intelligence (AI) engine 414 executing as described in greater detail below. The application engine 410 may include or be in communication with a sensor data receiver 416 for receiving data from one or more sensors associated with one or more assets associated with one or more buildings.

The application engine 410 may provide functionality for analyzing data and generating alerts. The application engine 410 may include functionality for generating reports, such as reports regarding utilities, assets, contractors, planet impact, building alert, service check, return on investment calculators, comparison, thermostat and HVAC data, data logger, equipment supplies, and other physical assets. The application engine 410 may include functionality for generating data relating to alert history, user alert submissions, current data review, service history, service record entries, historical reporting, process reporting, scenario analysis (e.g., A/B testing or “what-if” analyses), buildings, businesses, users and roles, alert catalogs, service catalogs, settings histories, and the user experience.

The application engine 410 may be in communication with one or more client computing devices 102a-n. Each of the client computing devices 102a-n may execute a copy of a building alerts application 420a-n with which to interact with the application engine 410, to receive alerts, and exchanging data relating to one or more buildings having one or more assets with the application engine 410.

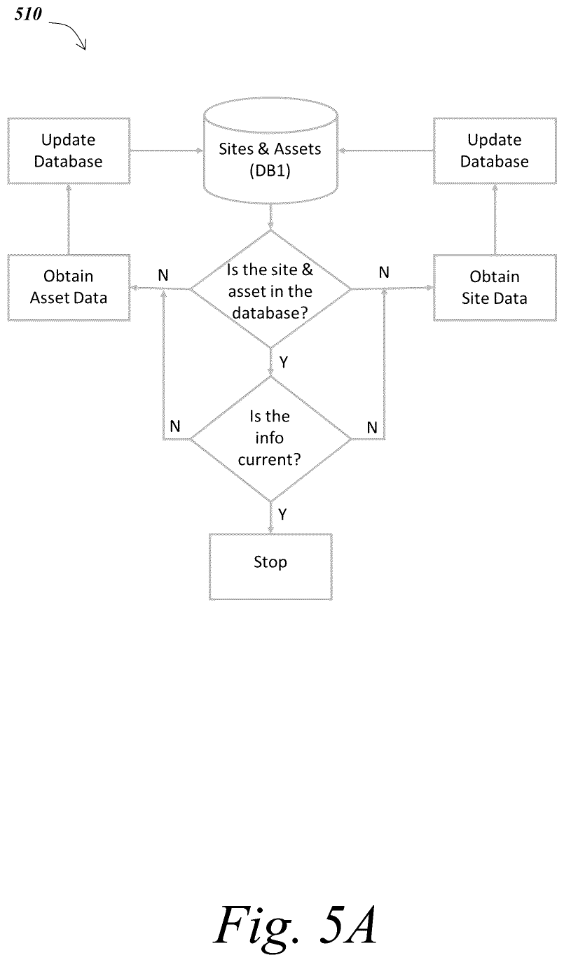

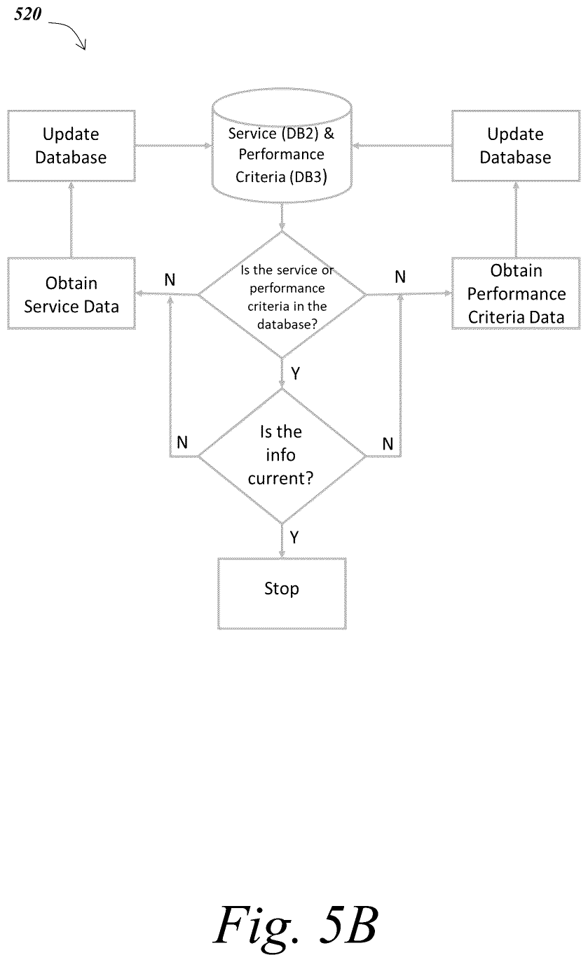

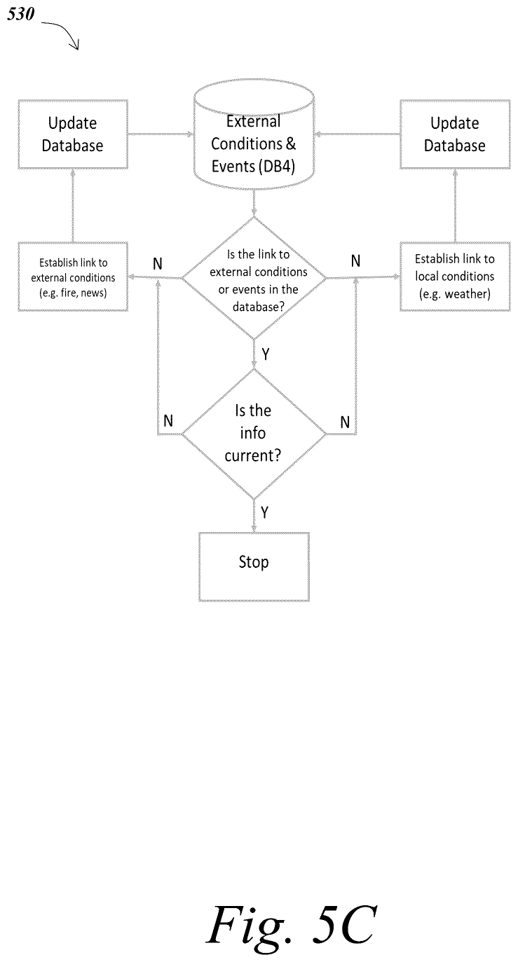

Referring now to FIG. 5A, a flow diagram depicts one embodiment of a method for determining whether to update a database in the system 400 with site data or asset data. As shown in FIG. 5A, the application engine 410 may access current information on assets and site information, along with the history of any changes to asset information site and determine whether to update data in one or more databases 120a-n (referred to generally as database 120). The application engine 410 may time stamp information entered to the database for historical tracking. The individual building assets include but are not limited to, purchase receipts; install date; installer information; make, model, and serial number; initial configuration settings; warranty information; and physical location information. The building asset also contains pricing and part information (e.g., part number and supplier) for replaceable parts to ensure building owners and tenants are efficient in conducting routine servicing. In addition, information related to changes to building assets, including but not limited to, changes to configuration settings and who made the change; and status (active, inactive, or removed). Data to populate the database may be obtained from receipts entered manually, asset documentation provided by service personnel, tenants, and building owner. As shown in FIG. 5A, the application engine 410 may determine whether a database 120 includes an identification of an asset associated with a site. If so, the application engine 410 may determine whether any information stored in the database in conjunction with the identified asset is current (e.g., based on an analysis of a timestamp associated with the information). If so, the application engine 410 may repeat the process for one or more other assets for a site and/or for one or more assets associated with another site. If the database does not include information associated with a site, the application engine 410 may obtain information associated with the site and update at least one database 120 with the information. If the database does not include data associated with an asset associated with a site, the application engine 410 may obtain information associated with the asset and update at least one database 120 with the information.

Referring now to FIG. 5B, a flow diagram depicts one embodiment of a method for determining whether to update a database in the system 400 with service data or performance criteria data. Information may be entered to the database and time stamped for historical tracking. Performance criteria for building assets may be defined as the optimum or desired performance level and the acceptable variance from this criterion. Variance levels may be categorized into normal performance, service investigation required, and service needed immediately. The criteria and variance data includes but is not limited to, expected runtime and non-runtime of asset per hour, day, or week; servicing intervals based on time elapsed, or runtime as recommended; and electrical current draw levels per hour, day, or month as appropriate. Each building asset has at least one defined service that can be performed on it to keep it operating at an optimum level. The services entered in the database define tasks such as, but not limited to, updating network configurations (such as WiFi or routers), replacing the battery, changing a filter, lubricating equipment, clearing sensors, details of the settings to be changed and to what level. The service may further detail who should conduct the service. Data to populate the database may be based on manufacturers recommendations and technical bulletins, service industry knowledge, and industry norms, and may be obtained electronically from manufacturers websites and notification systems, or manually entered information provided by service personnel, and industry organizations. Further, a Services database may contain an indication of whether the asset is covered by an Asset Service contract or not. If an Asset Service contract is in place, the database will contain information for each applicable asset including but not limited to contract start and end dates, service provider information, payment schedules, contract coverage (what is included and what is excluded within the contract).

The application engine 410 may determine whether a database 120 includes an identification of a service or of performance criteria. If so, the application engine 410 may determine whether any information stored in the database in conjunction with the identified service or performance criteria (e.g., based on an analysis of a timestamp associated with the information). If so, the application engine 410 may repeat the process for one or more other assets for a site and/or for one or more assets associated with another site. If the database does not include information associated with a service or with performance criteria, the application engine 410 may obtain information associated with the service or with performance criteria and update at least one database 120 with the information.

Referring now to FIG. 5C, a flow diagram depicts one embodiment of a method 530 for determining whether to update a database in the system 400 with external conditions and events data. External data may include user-generated data. All information entered to the database may be time stamped for historical tracking. Local external conditions are captured and recorded to provide potential information to help explain and understand asset performance variations. Local external conditions include but are not limited to, weather conditions such as temperature, humidity, wind, lightning, and precipitation; utility outages (including communications networks)—both planned and unplanned; fire; smoke, smog, and outdoor air quality. User generated concerns may also be entered into the database and are time stamped. User generated concerns can be observations of safety hazards, excessive use of resources (e.g., watering while it is raining), or any concern that requires further investigation and potential resolution. Each event has data parameters established to determine if data is within Normal Operating, Cautionary, and Extreme conditions. Data to populate the database may be obtained electronically from external sensors when available, local weather services, utility company outage reports, and local news reports, along with manual entered data ranges. Other events that may also be entered into the database including but are not limited to, fire, flood, and power outage. In addition to details of the event, pre-set levels of severity for each event are established to ensure the appropriate level of action is taken. Severity levels include No Event, Preparatory Action Required, and Evacuate Immediately. Data to populate the severity section of the database may be obtained locally from building owners and tenants and is manually entered. Actual event data is sourced electronically from building fire alarms, utility company alerts, and local news/weather alerts.

The application engine 410 may execute the same steps as depicted in FIG. to determine whether to update a database 120 with data relating to responsible personnel. Roles may be categorized such as, without limitation, building owner, business owner, asset service technician, utility company, and emergency response. For each role, specific personnel are identified along with their contact information.

The application engine 410 may execute the same steps as depicted in FIG. to determine whether to populate and/or update a database 120 with data relating to service tickets and service history for building assets. Information entered to the database may be time stamped for historical tracking. A service ticket template may be established to provide service personnel with the necessary information for addressing a need identified on the service ticket. This information includes, but is not limited to, asset name, location, service category and history, and related performance data. Historical service information may also be entered into the database when the system is initialized. Information includes, but is not limited to, service receipts; description of service performed; service date; servicer information; status indicator of whether the service was covered under warranty or not; and cost of service. This data may be obtained and manually entered from documentation provided by service personnel and/or building owner.

The application engine 410 may execute the same steps as depicted in FIG. to determine whether to populate and/or update databases for service integrity check and device alerts of building assets are populated and updated with alerts. Information entered to the database may be time stamped for historical tracking. Service integrity check alerts are generated for any of the following conditions, recommended service interval is approaching or has passed, service has been completed and new service data is received, or service interval has been exceeded. Service intervals are defined as Service Due, Service Past Due <30 days, Service Past Due >30 days. Service integrity check alerts may remain open and active until resolved. Once resolved, the service integrity check alert may be moved to the historical database.

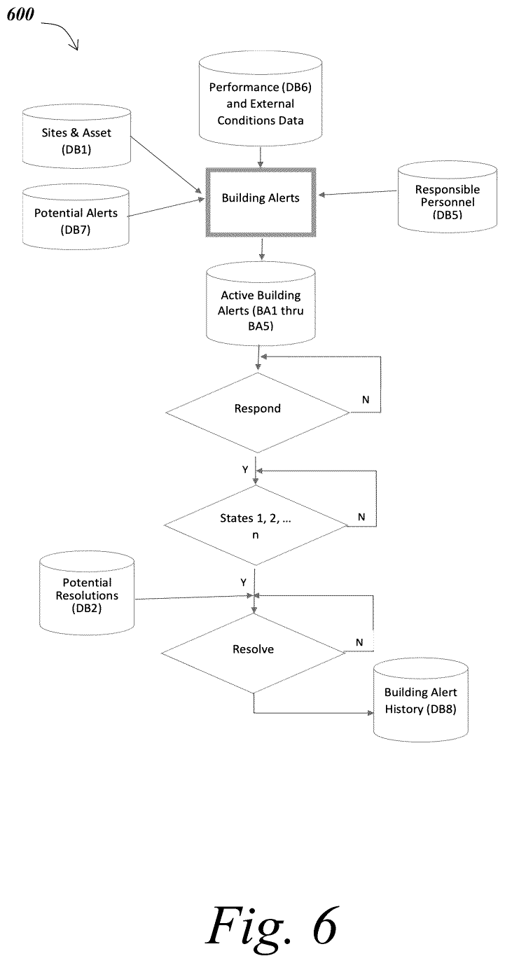

Referring now to FIG. 6, a flow diagram depicts one embodiment of a method for populating alert data in a system for generating and transmitting customized notifications regarding a status of at least one building asset. A database 120 may store data relating to building alerts. The application engine 410 may generate the alert data when data from one or more devices or data loggers indicates an exceeding of a threshold defined in a performance criteria database. Information entered to the database may be time stamped for historical tracking. The asset performance data may start with initial data from the time of device activation. New data may be compared to the initial data including but not limited to, consumable resource usage, temperature and humidity readings, air flow, and air quality. Building alerts may be categorized as data relating to health & wellness, thermal comfort, water, or consumable resource efficiency. If new data includes a value that exceeds a value specified by performance criteria variance levels previously established, the application engine 410 may generate an alert and store the alert in the alert database. When a scheduled servicing interval is identified as due, a reminder is generated and stored in the reminder database. Data to populate the database is obtained electronically from building assets on a settable time interval, and resource (electric, water, fuel) consumption data from utility companies electronically when available or manually entered. Potential resolutions to the building alert are also generated from the service database. Once the building alert has been resolved, the alert is stored in the building alert history database. After the service reminder has been addressed, the activity is stored in the service history database. Therefore, as shown in FIG. 6, the application engine 410 may determine that data received in connection with at least one asset for at least one site includes a value that exceeds a threshold level of values for the at least one asset, determine to generate an alert, and access a database 120 to retrieve responsible personnel data to determine to whom to send the generated alert.

Referring to again to FIG. 4 and in connection with FIGS. 1-3, the application engine 410 may execute the method 100 for collecting data, analyzing the collected data, generating at least one notification responsive to the analyzing of the collected data, transmitting the at least one notification to at least one user, prompting at least one user to take at least one action based on the generated at least one notification, and generating at least one report including information associated with the at least one action taken based on the generated and transmitted at least one notification. The application engine 410 may receive data (e.g., via a receiver 416) from one or more sensors and/or data loggers, as depicted in FIG. 2. The application engine 410 may execute one or more machine learning engines 412 and/or artificial intelligence engine 414 to analyze received data, identify characteristics of the received data, identify characteristics of the asset or assets associated with the received data and identify one or more actions to take based on the analysis and identifications. As depicted in FIG. 3, the application engine 410 may execute one or more workflows upon receiving data to execute the method 100 depicted in FIG. 1.

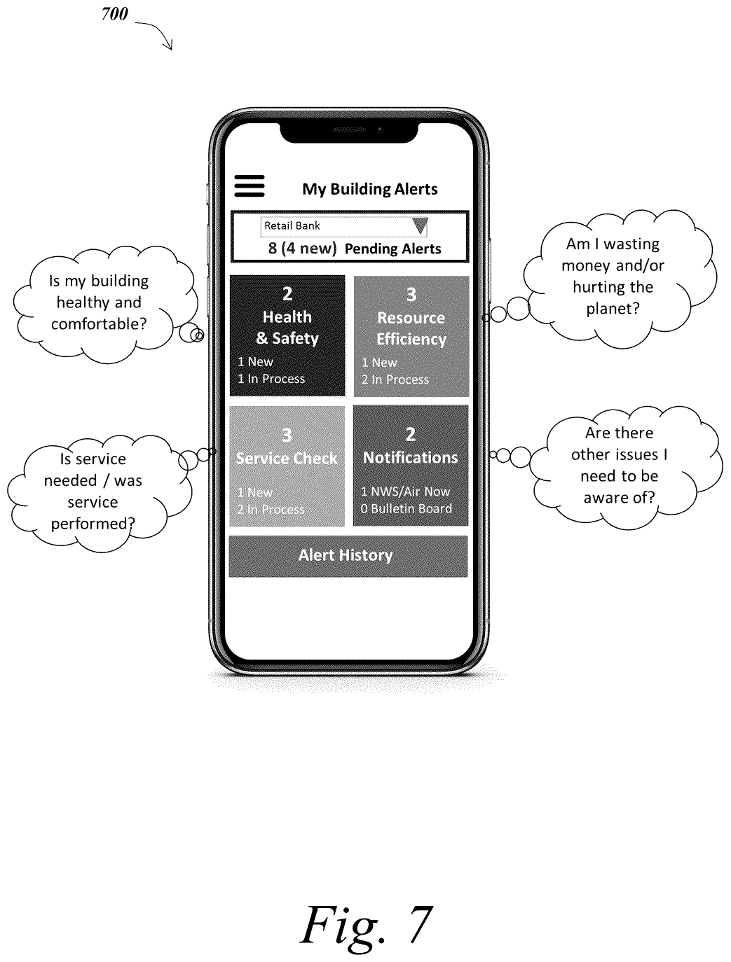

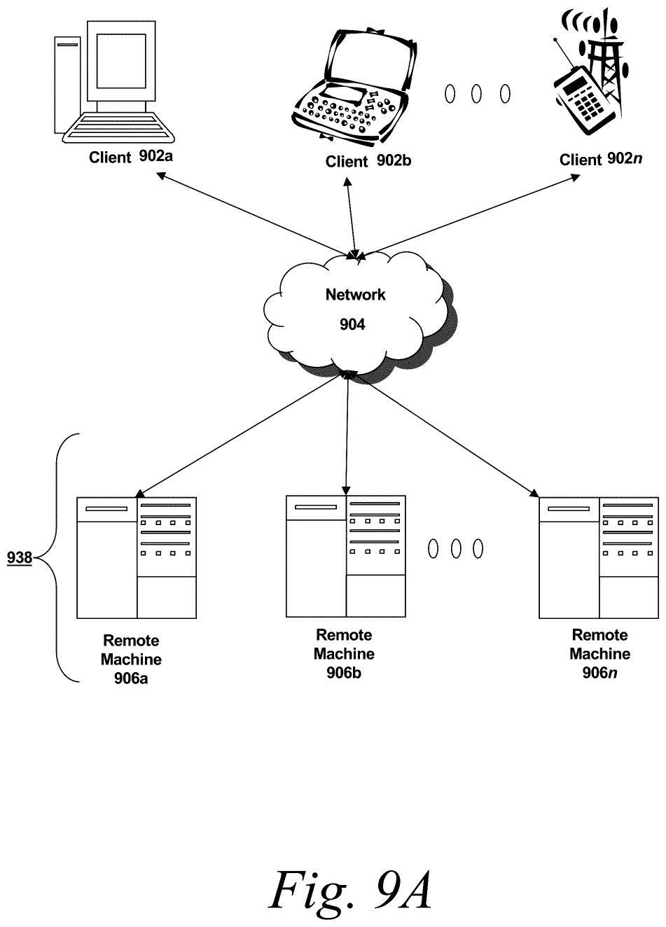

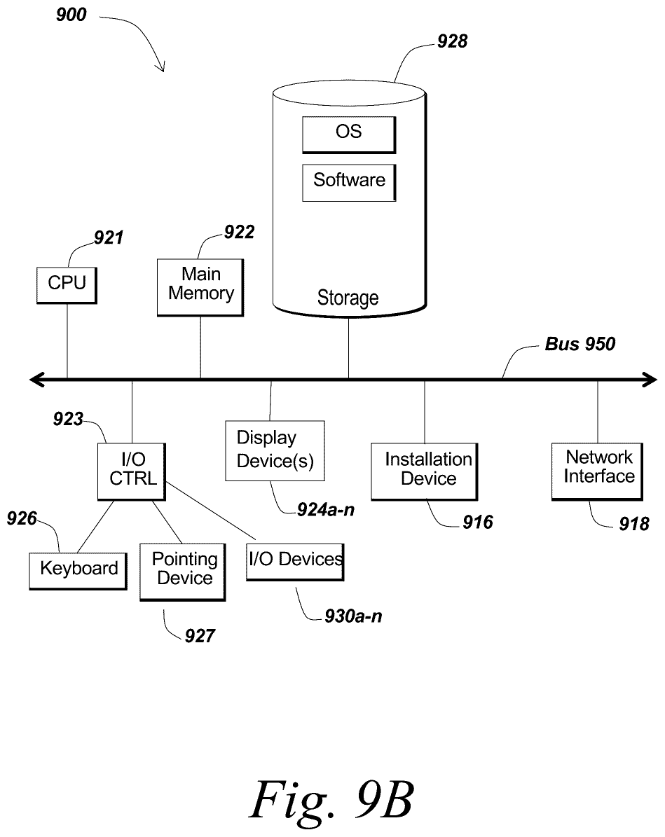

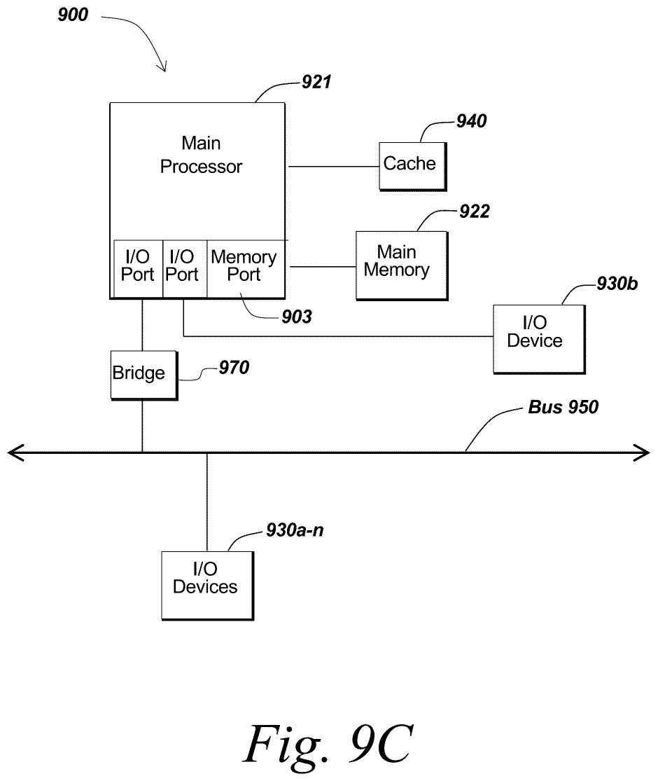

Referring now to FIG. 7, a block diagram depicts one embodiment of a user interface 700 of a building alerts application 420 with which users may interact with the application engine 410. As indicated above in connection with FIG. 4, the application engine 410 may communicate with one or more client devices 102a-n, each of which may be executing a building alerts application 420a-n. The building alerts application 420 may execute on mobile devices, e.g., smart phones, tablets, and/or laptops, or other computing devices 900 as described below in connection with FIGS. 9A-C. The building alerts application 420 may be used when not connected to the Internet and may synchronize data entered into the building alerts application 420 during the period of time without Internet connectivity to the application engine 410 once the building alerts application 420 is reconnected to the internet. Each user of a building alerts application 420 may be assigned a unique login and password and may be provided with functionality for resetting their passwords. Each user, with granted permission, can access one or more buildings as well as one or more businesses within a building and/or one or more building assets associated with a building. The building alerts application 420 may provide access to functionality for viewing and/or modifying settings. The building alerts application 420 may provide access to functionality related to alerts. The building alerts application 420 may provide access to functionality related to service integrity checks. The building alerts application 420 may provide access to functionality for executing one or more tools provided by the application engine 410 for the users. The building alerts application 420 may provide access to functionality for viewing and/or modifying settings.

The building alerts application 420 may generate and display a user interface providing access to functionality related to building alerts; such a user interface may allow users, based upon their roles, permissions, and settings, to access multiple buildings, businesses, and assets. The building alerts application 420 may display active alerts, both those that are new and those already in process. The building alerts application 420 may provide direct access to other functionality made available by the application engine 410, including a building alerts history application and a current data review application. New building alerts may be generated by the building alerts application 420 or may be received by the building alerts application 420 from the application engine 410. The building alerts application provides visibility to multiple building alert types including Urgent, Warning, Recommendations, and Reminders. Building alerts may be categorized into major categories including health and wellness, thermal comfort, service integrity check, and consumable resource efficiency.

The application engine 410 may execute a building alerts application as indicated above. The building alerts application may provide a guided workflow. In one embodiment, the guided workflow includes four potential alert states: New, Assigned, Investigating, Resolved. This path may execute when an alert is identified as an alert that may be resolved without requiring service. In one embodiment, the guided workflow includes seven potential alert states: New, Assigned, Investigating, Service Needed, Service Scheduled, Service Started, Resolved. This path may execute when an alert requires service to be performed to resolve the alert. For the Service-related states (Service Needed, Service Scheduled, Service Started, and Resolve), the building alert application may provide a list of one or more standard service offerings that can be selected for a service ticket, may provide access to documents including photos and receipts can be loaded to the active service ticket, may provide functionality for assigning different individuals for each service state, may attach data from the Current Data Review application to the resolution of the service request. The building alert application may generate a log record with a date/time stamp for each change of state; this enables audit trail and analytics on services performance capabilities. Stakeholders for an alert may then have access to the latest active alert state either via their selected notification or by using the building alerts application.

Each alert may have a unique configuration, which may be accessed, specified, and/or modified via the Settings application. In one configuration, an individual stakeholder may be assigned to respond to an alert, as it goes through one of the guided workflow paths described above and other stakeholders may be specified whom the building alerts application will inform about the status of the alert as the individual stakeholder progresses through different states leading to resolution. Individuals may be notified of alerts through the application itself, via text messages (e.g., messages sent via a Short Message Service), and/or via email.

The building alerts application 420 may provide functionality for viewing alert histories, which may allow users to view, print, download, and/or email historical (i.e., resolved) Building Alert information. Users may search for alerts based upon building, business, alert type, alert category, start date, and end date.

The building alerts application 420 may provide functionality with which users may submit new alerts. Although most building alerts will be automatically generated, users may want to submit alerts that they want building owners or other tenants to be aware of. The User Alert Submission interface provides the opportunity for users to enter alerts for buildings, businesses, and assets. Users may access this interface from the building alerts application 420.

The building alerts application 420 may provide functionality allowing users, depending on their assigned roles, permissions, and/or settings, to access multiple buildings, businesses, and assets. The building alerts application 420 may provide functionality allowing users to receive alerts when a service quality issue has been detected and when service integrity checks are in process but not yet passed or failed their automated service quality review. New service integrity check alerts may be generated by the Validate Application. The Service Integrity Check functionality of the building alerts application 420 also gives users access to other functionality, including the Service History functionality and the Current Data Review functionality. The Service Integrity Check functionality provides visibility to multiple building assets including Thermostats, HVAC, Water Heaters, Air Quality, and Loggers.

The Service Integrity Check functionality provided by the overall building alerts application 420 may provide users with a guided workflow. In one embodiment, the guided workflow includes four potential alert states: New, Assigned, Investigating, Resolved. This path may execute when an alert is identified as an alert that may be resolved without requiring service. In another embodiment, the guided workflow includes seven potential alert states: New, Assigned, Investigating, Service Needed, Service Scheduled, Service Started, Resolved. This path may execute when an alert requires service to be performed to resolve the alert. For the Service-related states (Service Needed, Service Scheduled, Service Started, and Resolve), the building alert application may provide a list of one or more standard service offerings that can be selected for a service ticket, may provide access to documents including photos and receipts can be loaded to the active service ticket, may provide functionality for assigning different individuals for each service state, may attach data from the Current Data Review application to the resolution of the service request. The building alert application 420 (or the service integrity check functionality of the overall building alert application 420) may generate a log record with a date/time stamp for each change of state; this enables audit trail and analytics on services performance capabilities. Stakeholders for an alert may then have access to the latest active alert state either via their selected notification or by using the building alerts application. The building alerts application 420 (or the service integrity check functionality of the overall building alert application 420) may provide access to functionality for viewing and/or modifying settings. The building alerts application 420 (or the service integrity check functionality of the overall building alert application 420) may provide access to functionality related to alerts. The building alerts application 420 (or the service integrity check functionality of the overall building alert application 420) may provide access to functionality related to service integrity checks. The building alerts application 420 (or the service integrity check functionality of the overall building alert application 420) may provide access to functionality for executing one or more tools provided by the application engine 410 for the users. The building alerts application 420 (or the service integrity check functionality of the overall building alert application 420) may provide access to functionality for viewing and/or modifying settings.

When responding to a Building Alert or a Service Integrity Check alert, users may want to view the latest data readings for all the sensors in a building that are available. This building alerts application 420 may provide functionality to review current data available (which may be referred to as a current data review application); this functionality may be accessed either from the Building Alerts application 420 or from the Service Integrity Check functionality of the application 420. Similarly, users may which to view service histories (e.g., to view, print, download, or email historical (i.e., resolved) asset service history information) or service records (including data relating to, e.g., service information including service provider, service technician, date of service, services provided, service category, asset name, and one or more services) and the building alerts application 420 may provide functionality for doing so.

The building alerts application 420 may provide additional tools beyond building alerts and service integrity check to improve proactive building habits. Users may use tools to generate reporting and analysis results, which can be viewed, printed, emailed, or downloaded in multiple formats including PDF, XLS, and CSV. Results may be saved for future reference. These additional tools may provide access to the following functionality: historical reporting, process reporting, and scenario analyses. The functionality for historical reporting provides users with tools that track actual utility, asset, and contractor utilization and spend and may also provide access to reporting functionality relating to utilities, assets, and contractor spending. Utilities charge their clients in multiple ways, including demand and consumption charges. The Utility Reporting functionality allows users to select the utility (e.g., all, electricity, gas, water), time period (yearly, monthly), start date, end date, and get a breakdown by different charges (e.g., overall, demand, consumption). Results may be saved for future reference. Users may want to track their demand rates over time and when they vary by time period, to understand when their peak demand is and to look for opportunities to reduce the peak demand charges. Users may choose a utility (e.g., electricity, gas, water) for a building or business, time period (e.g., daily, weekly, monthly, yearly), start date, end date, and appropriate filters including HVAC vs non-HVAC, weekdays vs. weekends. Users may want to track their consumption of electricity, fuel, and water to understand usage patterns and look for opportunities for utility consumption reduction. Users will be able to choose a utility (e.g., electricity, fuel, water) for a building or business, time period (e.g., daily, weekly, monthly, yearly), start date, end date, and appropriate filters including HVAC vs non-HVAC, weekdays vs. weekends. Users may want to track their utility spend for electricity, fuel, and water to understand their spending patterns and look for opportunities for utility cost reduction. Users will be able to choose a utility (e.g., electricity, fuel, water) for a building or business, time period (e.g., daily, weekly, monthly, yearly), start date, end date, and appropriate filters including HVAC vs non-HVAC, weekdays vs. weekends. Users may make better decisions about their assets if they have more information about those assets. The Asset Reporting functionality provides access to the Asset Degradation Application, Asset Spend, and Total Cost of Ownership Application. Users may want to track the performance degradation for assets, particularly those that have a high cost of operation (e.g., HVAC systems). The user will be able to choose from a list of assets within a building or business, a timeframe (e.g., monthly, yearly), a start date, and an end date. Users may want to track their spending on assets, including maintenance and repairs. Users will be able to choose from a list of assets within a building or business. Users may want to track the total cost of ownership for assets, particularly those that have a high cost to maintain, repair, or replace. Users may be able to choose from a list of assets within a building or business. Users can make better decisions about their contractor if they have more insights about those contractors. The Contractor Reporting functionality provides access to the Contractor Spend functionality, with which users can track spending on contractors and filter by criteria such as contractor company, contractor name, contractor start date, contractor end date, building, and/or business. The contractor reporting functionality may provide Contractor Quality functionality, with which users track contractor quality by reviewing multiple quality measures including time to respond, time to complete service calls, and % of successful service integrity checks. Users may be able to choose multiple criteria including contractor company, contractor name, start date, end date, building, and business. The building alerts application 420 may also provide functionality for tracking of building Green House Gas (GHG) emission and carbon footprint reduction to facilitate reporting to shareholders and government agencies.

To make better decisions and improve efficiency, users need tools that identify weaknesses and potential savings. The Process Reporting functionality provides access to the Building Alert Process Application, which allows users to review various process metrics about the Building Alerts process. For example, how long does it take to resolve a building alert, those generated by our system and those created by building stakeholders. The process reporting functionality may provide access to Service Integrity Check Process functionality, with which users may review process metrics relating to the service integrity check process such as the frequency with which the system 400 identifies a contractor servicing issue.

To make better decisions, users have access to tools that help them evaluate investments in their businesses and assets including the cost of doing nothing. The What-if Analysis application provides access to the ROI Calculator functionality and the Comparison functionality. With the ROI Calculator functionality users can estimate the return on investment for maintaining assets, repairing assets, replacing assets, or doing nothing. The user may choose from a list of available assets within a building or business, proposed service, and proposed service date and then a projection of return on investment will be displayed. To make better decisions, it is sometimes helpful to use benchmarks or Key Performance Indicators (KPIs). Benchmarks are reference points that users compare buildings, business, assets, contractors, and processes. Comparisons can be made against internal or external companies (such as competitors) or industry best practices. KPIs are used to track performance in relation to strategic goals. Users will be able to choose from a list of available buildings, businesses, and assets. Users can filter based upon multiple criteria including consumption and spend.

The building alerts application 420 may provide Settings functionality used to setup and configure the building alerts application 420 and related functionality provided by the application 420. The Settings functionality will provide access to functionality for modifying users and roles, buildings and businesses, thermostats and HVAC data, assets, and data loggers. Users may add, modify, or retire buildings and businesses based upon their permissions. Buildings must be added prior to being able to add a business within a building. Building profiles include address, building type, square footage, and utilities. Business profiles include type of business, square footage, and operating hours. Users may add, modify, or retire thermostats and HVAC systems based upon their permissions. HVAC systems must be added prior to being able to add a thermostat that controls a HVAC system. HVAC system profiles include building, business, brand, model, serial number, location, and photos. Thermostat profile includes brand, model, setpoint, fan setting, setback setpoint, setback fan setting. Users may add, modify, or retire equipment supplies based upon their permissions. Equipment supplies are those items that are used to maintain, repair, or replace HVAC units, thermostats, data loggers, and other physical assets. Equipment supplies profile will include original equipment unique identifier, part number, preferred purchaser, and price. Users may add, modify, or retire other building physical assets based upon their permissions. Physical assets can include equipment that should be properly maintained, repaired if it is broken, and replaced when no longer usable. Physical asset profile will include equipment type, brand, model, date installed, unique serial number, and location. Users may add, modify, or retire data loggers based upon their permissions. Data logger profile will include brand, model, data installed, unique serial number, and location. Users may be invited or added directed based upon permissions. User profiles may be added, modified, or retired. User information includes name, role, and contact information (e.g., cell phone, email). Users can subscribe to permitted buildings, businesses, and assets. Users can choose one or more notification channels (e.g., the application 420, email, text) and frequency by alert severity. Users are presented with standard alerts, which then need to be activated and configured for building stakeholders including building owners, business owners, contractors, employees, and customers. Standard alerts may also need to be customized for specific use cases. Custom alerts can also be added, activated, and configured. After activation and initial configuration, alerts may also be modified or deactivated. Users are presented with a standard list of service offerings, which then need to be activated and configured for building stakeholders including building owners, business owners, contractors, employees, and customers. Standard services may also need to be customized for specific use cases. Custom services can also be added, activated, and configured. After activation and initial configuration, services may also be modified or deactivated. There are situations when users may want to lookup previous application settings including businesses, buildings, thermostats, HVAC, water heaters, other physical assets, data logger, users and roles, alert inventory, and service inventory. For example, who was the previous contractor who provided services for a HVAC unit. Users can access the Settings History Application from the Settings Application.

Referring still to FIG. 7, the user interface 700 provides functionality for communication to interested parties the current condition of the building and its assets, functionality for receiving and acknowledging alerts, functionality for viewing service integrity check status, and functionality for updating and configuring one or more databases 120.

As depicted in FIG. 7, the user interface provides functionality with which to address concerns of tenants and building owners, such as, without limitation: building health, building comfort, services needed, services completed, and energy efficiency.

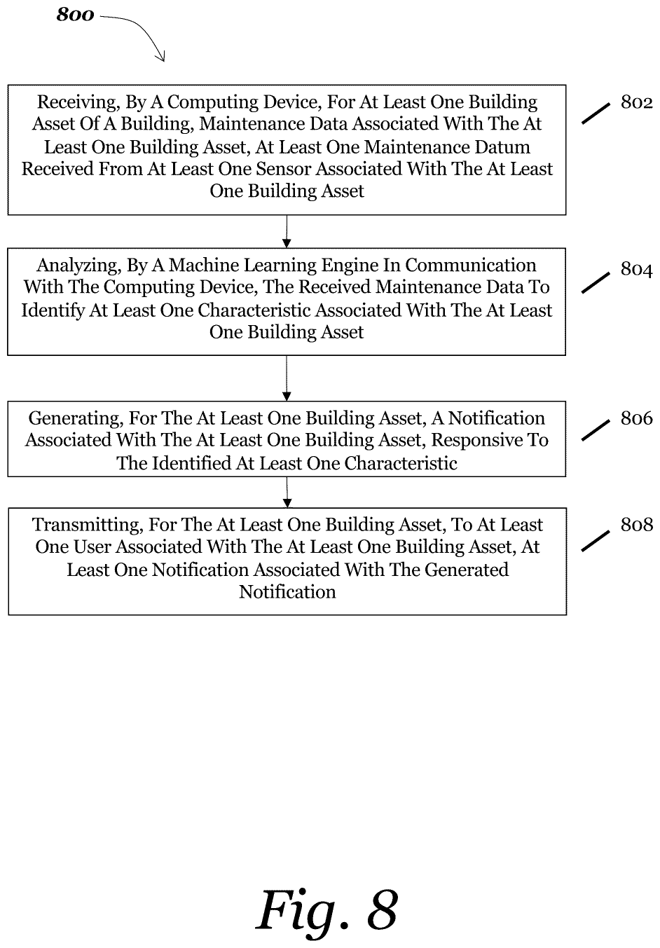

Referring ahead to FIG. 8, a flow diagram depicts one embodiment of a method Boo for generating and transmitting customized alerts regarding a status of at least one building asset of a building. In brief overview, the method Boo includes receiving, by a computing device, for at least one building asset of a building, maintenance data associated with the at least one building asset, at least one maintenance datum received from at least one sensor associated with the at least one building asset (802). The method Boo includes analyzing, by a machine learning engine in communication with the computing device, the received maintenance data to identify at least one characteristic associated with the at least one building asset (804). The method Boo includes generating, for the at least one building asset, a notification associated with the at least one building asset, responsive to the identified at least one characteristic (806). The method Boo includes transmitting, for the at least one building asset, to at least one user associated with the at least one building asset, at least one notification associated with the notification (808).

Referring now to FIG. 8 in greater detail and in connection with FIGS. 1-7, the method Boo includes receiving, by a computing device, for at least one building asset of a building, maintenance data associated with the at least one building asset, at least one maintenance datum received from at least one sensor associated with the at least one building asset (802). The receiving may further comprise receiving for at least one building asset, maintenance data associated with the at least one building asset, a second maintenance datum received from at least one data logger associated with the at least one building asset. The receiving may further comprise receiving for at least one building asset, maintenance data associated with the at least one building asset, a second maintenance datum received from at least one service record associated with the at least one building asset. The receiving may further comprise receiving for at least one building asset, maintenance data associated with the at least one building asset, a second maintenance datum received from at least one consumption record associated with the at least one building asset. The receiving may further comprise receiving for at least one building asset, maintenance data associated with the at least one building asset, a second maintenance datum received from at least one third party source of environmental data associated with the at least one building asset.

The method Boo includes analyzing, by a machine learning engine in communication with the computing device, the received maintenance data to identify at least one characteristic associated with the at least one building asset (804). As described above in connection with FIG. 4, the machine learning engine 412 may analyze data received via a receiver 416. The machine learning engine 412 may also or alternatively analyze data received directly by the application engine 410, e.g., digital images or data provided by users via the building alerts application 420. The machine learning engine 412 may analyze a digital image to identify the at least one characteristic. As depicted in FIG. 4, the system 400 may execute a machine learning engine 412. As building owners may or may not have records of make, model, and year installed for any or all of their assets, the methods described herein may include execution of one or more artificial intelligence engines 414 to both analyze received data and to identify characteristics and/or information missing from received data. An AI engine 414 may include a machine learning engine 412. The AI engine 414 may include a computer vision engine. The AI engine 414 may include an optical character recognition engine.

The system 400 may execute a method for identifying a building asset, the method including receiving a digital image. The system 400 may receive the digital image from a user of the building alerts application 420. The digital image may be an image of an original purchase document. The digital image may be an image of an assert nameplate. The method may include analyzing, by a computer vision engine (not shown in FIG. 4), the received digital image. The computer vision engine may analyze the nameplate image to capture make, model, serial number, date manufactured, and fuel type in the case of HVAC. The computer vision engine may be trained to review various nameplates by analyzing nameplate nomenclature in order to identify the various fields on the nameplate in order to populate the necessary database. In addition, or instead of, the computer vision engine, the machine learning engine 412 may analyze the make, model, and serial numbers to determine date of manufacture (if otherwise unavailable), fuel type, and warranty information. The machine learning engine 412 may be trained by reviewing hundreds of manufacturer websites for make, model, and serial number structure to analyze nameplate data provided. Fuel type captured by Computer Vision may be validated against utility bills to ensure consistency (e.g., if the HVAC is identified as fueled by Natural Gas, then there must be a Natural Gas utility bill available). The digital image may include paper record scans, which may be analyzed by the machine learning engine 410 and/or by an optional optical character recognition (OCR) engine (not shown in FIG. 4) to capture and populate a database 120. While OCR can capture text and handwriting, field structure of forms may be inconsistent and varied; therefore, the machine learning engine 412 may be configured to look for specific data to ensure proper classification of the data and placement in the necessary database.

Entering service records for building assets is a tedious manual process that is error prone and a low priority task, but very important to determine the life expectancy of the building asset, the quality of the service performed, failure analysis, and a host of other insights. In addition, the service history is an important tool in assisting in repair or replacement decisions. To facilitate the populating of the service history databases, and to capture future services, the system may execute engines for one or more of: Computer Vision, OCR, and Machine Learning. For historical service records, the machine learning engine 412 and/or an OCR engine may analyze paper copies of work orders and/or invoices (obtained by smartphone image or digital scans or otherwise provided to the system 400) capture data and populate a database 120. While OCR can capture text and handwriting, field structure of forms may be inconsistent and varied; therefore, the machine learning engine 412 may be configured to look for specific data to ensure proper classification of the data and placement in the necessary database. The machine learning engine 412 may be trained to look for date of service, contact information of the service technician and company, description of service performed, information of parts added or replaced, cost of the labor performed, cost of the parts, warranty information, any miscellaneous notes. A digital image (e.g., from a camera or smartphone) of the defective part and the replacement part may be captured and uploaded to the necessary database.

The method Boo includes generating, for the at least one building asset, a notification associated with the at least one building asset, responsive to the identified at least one characteristic (806). The notification may be a service reminder. The notification may be an alert. The notification may be a notification of an insight. The notification may be a health and wellness check. The notification may be a consumable resource efficiency analysis result.

The method Boo includes transmitting, for the at least one building asset, to at least one user associated with the at least one building asset, at least one notification associated with the notification (808). The method Boo may include transmitting at least one alert associated with the notification. The method Boo may include transmitting at least one report associated with the notification. The method Boo may include transmitting at least one reminder associated with the notification.

The method Boo may include generating, by the machine learning engine 412, at least a second characteristic of the building asset, and transmitting the at least one notification may further comprise transmitting at least one report including the at least the second characteristic, and generating, for the at least one building asset, a first model for a first return on investment of completing an action identified in the notification and a second model for a second return on investment of not completing the action identified in the notification and transmitting the at least one notification may include providing a graphical user interface modified to display the first model and the second model. Based on service records, age of the asset, and manufacturer recommendations for routine maintenance, along with local environmental characteristics, the machine learning engine 412 may generate one or more predictions of future points of failure and may make one or more recommendations to prevent loss of service and extend the life of the asset. Based on service records, age of the asset, and manufacturer recommendations for routine maintenance, along with consumable resource usage history, the system 400 may execute a method for generating such recommendations. The method may include executing the machine learning engine 412 to assess and predict future maintenance and repair costs and then compare these costs to the cost of upgrading or replacing the asset with a more consumable resource efficient model.

The method Boo may include receiving for at least one building asset, maintenance data associated with the at least one building asset, a second maintenance datum received from at least one service record associated with the at least one building asset; analyzing the received second maintenance datum; and generating a report describing a level of compliance with a service metric based upon the analysis.

Based on historical actions, the method may include training the machine learning engine 412 to provide improved guidance to users as to root cause of issues, recommendations based on trends and previous servicing experience (what worked, what did not, what produced the best outcome), and other insights such as consumption of consumable resources (such as changes in water consumption compared to past trends, outdoor weather, irrigation system issues, potential water leaks, or unexplained usage during off-normal hours). The method may further utilize artificial intelligence (e.g., execution of the machine learning engine 412) to refine notifications and alerts priorities based on past actions and business goals. The method may further utilize the machine learning engine 412 to refine validation techniques to confirm the effectiveness of actions or the need for new or repeat actions.

Therefore, the methods and systems described herein may include a method for providing building owners, tenants, and interest third parties with a software enabled process to achieve business goals and minimize risk to health, safety, and the environment comprising collection of data and establishing associated parameters; assessing the data against models created for this purpose; informing with insights and creating necessary alerts and reminders; taking appropriate action be it preventative, corrective, or routine; and reviewing to validate the actions taken meet expectations. Such a method may include acquiring data from assets, devices, data loggers, servicing records, and consumption records such as but not limited to meters, utility bills. Such a method may include independent data collection using data loggers uniquely separate from the asset being monitored to provide validation of asset performance vs relying on internal asset reporting. Such a method may include establishing all the parameters associated with the data such as building and asset information, environmental settings, external factors, and responsible parties. Such a method may include the data presented as summarized, organized, and analyzed information. Summary information includes but is not limited to time bins (hourly, daily, weekly, monthly, annually) and by type (such as HVAC or Water Heater). Organized information includes but is not limited to grouping of time bins (such as consumable resource usage for occupancy hours and non-occupied hours) and for like conditions (such as outdoor weather conditions and the same environmental settings such as temperature). Analyzed information includes but is not limited to status of assets or devices such as compressor or fan state (on/off), duration, accumulated run time of compressor or fan. Such a method may include modeling of the data into descriptive, predictive, and prescriptive information but utilizing various modeling types such as but not limited to statistical, simulation, rules based, and machine/deep learning. Such a method may include providing remote access from any web enabled device to the information, from any location regardless of day or time, and making it available to all interested parties for further analysis or consumption. Such a method may include comparing the information against pre-established thresholds to alert responsible parties of conditions and/or events that require addressing, and the level of urgency associated with these alerts. Such a method may include comparing the information against recommended service intervals to alert responsible parties of servicing that is coming due and the appropriate component and part number to complete the service. Such a method may include providing warranty and service contract information to building owners, tenants, and service personnel to assist in the execution of any associated asset servicing. Such a method may include the initiation of preventative, corrective and/or routine actions based on the insights, alerts, and reminders generated to building owners, tenants, and service personnel. Such a method may include the review and validation of actions taken against expectations to determine if further actions are needed. Such a method may include a pre- and post-cost benefit analysis of providing service (such as, preventative maintenance or repair), or asset replacement, or take no action. Such a method may include an automated workflow to drive accountability, responsiveness, timely resolution, the collection of asset servicing, and comparison of pre- and post-asset performance. Such a method may include a continual review of the CAITR process ensuring continuous improvement and refinement of the process.

The methods and systems described herein may include a method of transparently alerting all persons of conditions affecting building health and safety, thermal comfort, consumable resource efficiency, any building asset that may require servicing and notifying all persons of the resolution to the alerts, via a software enabled process. Such a method may include the recommended servicing steps, and the scheduling of building asset servicing and preventative maintenance. Such a method may include the production of data for trend analysis to assist in the efficient use of consumable resources. Such a method may include the establishing and maintaining databases of; building information and building assets, expected building asset performance criterion and asset servicing, external events and conditions, roles and responsibilities of building, tenant, and servicing personnel. Such a method may include collecting data from building assets, data loggers, and external links for comparison against expected performance criteria and servicing intervals, to generate alerts to appropriate personnel when the collected data is outside of acceptable performance variable ranges or limits. Such a method may include reviewing building assets for recommended servicing intervals, to generate service reminders to appropriate personnel when the calendar date for service, or elapsed time since last scheduled service has been met or exceeded. Such a method may include keeping alerts and reminders open until resolved. These alerts and reminders are then archived for future analysis. Such a method may include a software application to provide a User Interface to communicate alerts, notifications, reminders, and resolution to building owners, tenants, service personnel, and interested third parties. Further the User Interface will be used to populate databases, algorithms to generate alerts based on configuration parameters, receive, and acknowledge alerts, and provide timely information on building asset performance.

The methods and systems described herein may include a method of providing service integrity checks on building assets recording when they were last serviced to compare changes in asset performance against history, manufacturers recommendations, and industry norms, and did the service provide the asset owner with value. Such a method may include establishing and maintaining databases of service tickets and building asset servicing history. Such a method may include generating service integrity check alerts when building asset servicing is required resultant from a pre-determined servicing interval has been met, or a building alert has necessitated a service request. Such a method may include keeping alerts open until resolved. These alerts are then archived for future analysis. Such a method may include communication to all interested people the results of service integrity checks. Such a method may include a software application to provide a User Interface to populate databases, algorithms to generate alerts based on configuration parameters, receive, and acknowledge alerts, and provide timely information on building asset performance.

The methods and systems described herein may include a method of utilizing computer technology to execute the CAITR method described above to provide immediate access to alerts, notifications, data, system management, and reports to any authorized user, from any web enabled computer device, from any location, and any time of day or night. Such a method may include purpose built software applications to provide users with access to Building Alerts, Service Integrity Checks, a Toolkit for managing historical reporting, process reporting, and What-if Analysis, and the ability to manage settings to manage databases, users and roles, the creation and management of Alerts, Services, and storage of settings transactions for audit purposes.

In some embodiments, the system 100 includes non-transitory, computer-readable medium comprising computer program instructions tangibly stored on the non-transitory computer-readable medium, wherein the instructions are executable by at least one processor to perform each of the steps in the methods described above.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (i) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 9A, 9B, and 9C, block diagrams depict additional detail regarding computing devices that may be modified to execute novel, non-obvious functionality for implementing the methods and systems described above.

Referring now to FIG. 9A, an embodiment of a network environment is depicted. In brief overview, the network environment comprises one or more clients 902a-902n (also generally referred to as local machine(s) 902, client(s) 902, client node(s) 902, client machine(s) 902, client computer(s) 902, client device(s) 902, computing device(s) 902, endpoint(s) 902, or endpoint node(s) 902) in communication with one or more remote machines 906a-906n (also generally referred to as server(s) 906 or computing device(s) 906) via one or more networks 904.

Although FIG. 9A shows a network 904 between the clients 902 and the remote machines 906, the clients 902 and the remote machines 906 may be on the same network 904. The network 904 can be a local area network (LAN), such as a company Intranet, a metropolitan area network (MAN), or a wide area network (WAN), such as the Internet or the World Wide Web. In some embodiments, there are multiple networks 904 between the clients 902 and the remote machines 906. In one of these embodiments, a network 904′ (not shown) may be a private network and a network 904 may be a public network. In another of these embodiments, a network 904 may be a private network and a network 904′ a public network. In still another embodiment, networks 904 and 904′ may both be private networks. In yet another embodiment, networks 904 and 904′ may both be public networks.

The network 904 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 904 may comprise a wireless link, such as an infrared channel or satellite band. The topology of the network 904 may be a bus, star, or ring network topology. The network 904 may be of any such network topology as known to those ordinarily skilled in the art capable of supporting the operations described herein. The network 904 may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 902 and a remote machine 906 (referred to generally as computing devices 900 or as machines 900) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 902 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high performance computing) application, a data processing application, or any other type and/or form of executable instructions capable of executing on client 302.

In one embodiment, a computing device 906 provides functionality of a web server. The web server may be any type of web server, including web servers that are open-source web servers, web servers that execute proprietary software, and cloud-based web servers where a third party hosts the hardware executing the functionality of the web server. In some embodiments, a web server 906 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the ORACLE WEBLOGIC products provided by Oracle Corporation of Redwood Shores, CA.

In some embodiments, the system may include multiple, logically-grouped remote machines 906. In one of these embodiments, the logical group of remote machines may be referred to as a server farm 938. In another of these embodiments, the server farm 938 may be administered as a single entity.

FIGS. 9B and 9C depict block diagrams of a computing device 900 useful for practicing an embodiment of the client 902 or a remote machine 906. As shown in FIGS. 9B and 9C, each computing device 900 includes a central processing unit 921, and a main memory unit 922. As shown in FIG. 9B, a computing device 900 may include a storage device 928, an installation device 916, a network interface 918, an I/O controller 923, display devices 924a-n, a keyboard 926, a pointing device 927, such as a mouse, and one or more other I/O devices 930a-n. The storage device 928 may include, without limitation, an operating system and software. As shown in FIG. 9C, each computing device 900 may also include additional optional elements, such as a memory port 903, a bridge 970, one or more input/output devices 930a-n (generally referred to using reference numeral 930), and a cache memory 940 in communication with the central processing unit 921.

The central processing unit 921 is any logic circuitry that responds to and processes instructions fetched from the main memory unit 922. In many embodiments, the central processing unit 921 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include RISC-V processors, SPARC processors, ARM processors, and processors for mobile devices. The computing device 900 may be based on any of these processors, or any other processor capable of operating as described herein.

Main memory unit 922 may be one or more memory chips capable of storing data and allowing any storage location to be directly accessed by the microprocessor 921. The main memory 922 may be based on any available memory chips capable of operating as described herein. In the embodiment shown in FIG. 9B, the processor 921 communicates with main memory 922 via a system bus 950. FIG. 9C depicts an embodiment of a computing device 900 in which the processor communicates directly with main memory 922 via a memory port 903. FIG. 9C also depicts an embodiment in which the main processor 921 communicates directly with cache memory 940 via a secondary bus, sometimes referred to as a backside bus. In other embodiments, the main processor 921 communicates with cache memory 940 using the system bus 350.

In the embodiment shown in FIG. 9B, the processor 921 communicates with various I/O devices 930 via a local system bus 950. Various buses may be used to connect the central processing unit 921 to any of the I/O devices 930, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 924, the processor 921 may use an Advanced Graphics Port (AGP) to communicate with the display 924. FIG. 9C depicts an embodiment of a computing device 900 in which the main processor 921 also communicates directly with an I/O device 930b via, for example, HYPERTRANSPORT, RAPIDIO, or INFINIBAND communications technology.

One or more of a wide variety of I/O devices 930a-n may be present in or connected to the computing device 900, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 923 as shown in FIG. 9B. Furthermore, an I/O device may also provide storage and/or an installation medium 916 for the computing device 300. In some embodiments, the computing device 900 may provide USB connections (not shown) to receive handheld USB storage devices such as the USB Flash Drive line of devices manufactured by Twintech Industry, Inc. of Los Alamitos, CA.

Referring still to FIG. 9B, the computing device 900 may support any suitable installation device 916, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 900 may provide functionality for installing software over a network 904. The computing device 900 may further comprise a storage device, such as one or more hard disk drives or redundant arrays of independent disks, for storing an operating system and other software. Alternatively, the computing device 900 may rely on memory chips for storage instead of hard disks.

Furthermore, the computing device 900 may include a network interface 918 to interface to the network 904 through a variety of connections including, but not limited to, standard telephone lines, LAN or WAN links (e.g., 802.11, Ti, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.1 in, 802.15.4, Bluetooth, ZIGBEE, CDMA, GSM, WiMax, and direct asynchronous connections). In one embodiment, the computing device 900 communicates with other computing devices 900′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 918 may comprise a built-in network adapter, network interface card, PCMCIA network card, card bus network adapter, wireless network adapter, USB network adapter, modem, or any other device suitable for interfacing the computing device 900 to any type of network capable of communication and performing the operations described herein.

In further embodiments, an I/O device 930 may be a bridge between the system bus 950 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 900 of the sort depicted in FIGS. 9B and 9C typically operates under the control of operating systems, which control scheduling of tasks and access to system resources. The computing device 900 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, WINDOWS VISTA, and WINDOWS 10 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linux-variant operating system distributed by Red Hat, Inc., of Raleigh, NC; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

Having described certain embodiments of methods and systems for generating and transmitting customized notifications regarding a status of at least one building asset, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for generating and transmitting customized alerts regarding a status of at least one building asset of a building, the method comprising:
receiving, by a computing device, for at least one building asset of a building, maintenance data associated with the at least one building asset, at least one maintenance datum received from at least one sensor associated with the at least one building asset;
analyzing, by a machine learning engine in communication with the computing device, the received maintenance data to identify at least one characteristic associated with the at least one building asset;
generating, for the at least one building asset, a notification associated with the at least one building asset, responsive to the identified at least one characteristic; and
transmitting, for the at least one building asset, to at least one user associated with the at least one building asset, at least one notification associated with the generated notification.

2. The method of claim 1, wherein receiving further comprises receiving for at least one building asset, maintenance data associated with the at least one building asset, a second maintenance datum received from at least one data logger associated with the at least one building asset.

3. The method of claim 1, wherein receiving further comprises receiving for at least one building asset, maintenance data associated with the at least one building asset, a second maintenance datum received from at least one service record associated with the at least one building asset.

4. The method of claim 1, wherein receiving further comprises receiving for at least one building asset, maintenance data associated with the at least one building asset, a second maintenance datum received from at least one consumption record associated with the at least one building asset.

5. The method of claim 1, wherein receiving further comprises receiving for at least one building asset, maintenance data associated with the at least one building asset, a second maintenance datum received from at least one third party source of environmental data associated with the at least one building asset.

6. The method of claim 1 further comprising generating, by the machine learning engine, the notification further comprises generating a service reminder.

7. The method of claim 1 further comprising generating, by the machine learning engine, the notification further comprises generating an alert.

8. The method of claim 1 further comprising generating, by the machine learning engine, the notification further comprises generating a notification of an insight.

9. The method of claim 1 further comprising generating, by the machine learning engine, the notification further comprises generating a health and wellness check.

10. The method of claim 1 further comprising generating, by the machine learning engine, the notification further comprises generating a result of an efficiency analysis of a consumable resource.

11. The method of claim 1, wherein transmitting the at least one notification further comprises transmitting at least one alert associated with the notification.

12. The method of claim 1, wherein transmitting the at least one notification further comprises transmitting at least one report associated with the notification.

13. The method of claim 1, wherein transmitting the at least one notification further comprises transmitting at least one reminder associated with the notification.

14. The method of claim 1 further comprising generating, by the machine learning engine, at least a second characteristic of the building asset.

15. The method of claim 14, wherein transmitting the at least one notification further comprises transmitting at least one report including the at least the second characteristic.

16. The method of claim 1 further comprising generating, for the at least one building asset, a first model for a first return on investment of completing an action identified in the notification and a second model for a second return on investment of not completing the action identified in the notification.

17. The method of claim 16, wherein transmitting the at least one notification includes providing a graphical user interface modified to display the first model and the second model.

18. The method of claim 1 further comprising:
receiving data associated with a response to the notification;
generating an audit trail associated with the response; and
generating at least one report providing an analysis of the response.

19. The method of claim 1 further comprising:
receiving for at least one building asset, maintenance data associated with the at least one building asset, a second maintenance datum received from at least one service record associated with the at least one building asset;
analyzing the received second maintenance datum; and
generating a report describing a level of compliance with a service metric based upon the analysis.
